(19) United States
(12) Patent Application Publication
(10) Pub. No.: US 2006/0183387 A1
(43) Pub. Date: Aug. 17, 2006

(54) Composite board

(76) Inventors: Steven L. Taylor, Glendora, CA (US); Mark A. Longfellow, Foothill Ranch, CA (US); Norman C. Tracy, Huntington Beach, CA (US); Robert R. Henderson, Tustin, CA (US); Michael Chang, Irvine, CA (US); Roland S. Weber JR., Rancho Palos Verdes, CA (US)

Correspondence Address: FULWIDER PATTON, 6060 CENTER DRIVE, 10TH FLOOR, LOS ANGELES, CA, 90045, US

(21) Appl. No.: 11/304,987

(22) Filed: Dec. 14, 2005

Related U.S. Application Data
(63) Continuation-in-part of application No. 10/236,053, filed on Sep. 4, 2002, now abandoned.

(51) Int. Cl. B32B 5/24

(52) U.S. Cl. 442/30; 442/35; 442/42; 442/43; 442/45; 442/46; 442/48; 442/49; 442/164; 442/180; 428/304.4; 428/318.4; 442/370; 442/221

(57) ABSTRACT

A composite board for use as backerboard for tile includes outer reinforcement portions and a polystyrene layer disposed between the two outer reinforcement portions, at least one of the outer reinforcement portions being an outer mat fabric reinforcement layer with a mat fabric, and a non-shrinking cement compound saturating and connecting the two outer portions with the polystyrene substrate. A method of installing a composite tile backerboard involves placing the composite board against a fixture protruding from a flat surface, pressing the composite board against the fixture to emboss the features of the fixture on the surface of the composite board, and cutting a hole in the composite board based upon the features of the fixture embossed on the composite board.

### CROSS-REFERENCES TO RELATED APPLICATIONS

This is a continuation-in-part of co-pending Ser. No. 10/236,053, filed Sep. 4, 2002.

### BACKGROUND OF THE INVENTION

This invention generally relates to a structural panel suitable for use in construction of walls, floors, countertops, and the like, particularly where high moisture conditions are encountered, such as in a shower enclosure or bathtub wall. More particularly, the invention relates to an improved composite board made of a planar core of expanded polystyrene, and outer reinforcement layers including a reinforcement fabric and a cement compound.

Ordinary gypsum based panels such as those used in dry wall construction commonly are not sufficiently resistant to moisture to permit successful use of such gypsum based panels in places such as a shower enclosure or bathtub wall. Ceramic tile mounted upon such gypsum panels, even though well grouted, will in a short time typically come loose, and the gypsum panels will disintegrate, due to penetration of moisture. Where the substrate for a tile overlay comprises ordinary gypsum plaster, the moisture from the tub or shower will be absorbed by the gypsum plaster which will disintegrate, causing the gypsum plaster to weaken, and permitting the tiles to come loose. Because of these difficulties due to moisture in bathrooms, shower areas, kitchens or other areas where water is present, at least at times, it has been necessary in constructing such walls, floors, countertops and the like, to use a concrete base or other special treatment.

Prior attempts at making a suitable tile backerboard generally include cementitious backerboards, composite fiber cement boards, coated gypsum based boards, hybrid based boards, and extruded foam boards. Conventional cementitious backerboards are typically sturdy and water resistant, but are also typically heavy, brittle and hard to work with. Conventional composite fiber cement boards are generally sturdy, clean cutting, and water resistant, but are also typically heavy, difficult to cut, and difficult to nail. Hybrid based boards are generally economical and easy to install but are also heavy, and gypsum based. Extruded foam boards are generally light, rigid and sturdy, but are expensive. In addition, special fasteners are generally required to mount the board, and the board must be scored on both sides to be broken.

Installation of tile backerboard typically requires cutting of access holes on the backerboard to fit over protruding fixtures on floors, countertops and walls. Common protrusions in a tile installation include water supply pipes, drain pipes, toilet flanges, sinks, and electrical boxes. The traditional method for locating and marking the cutting of these holes in the backerboard is done by carefully measuring the distance of the protrusions from an existing wall or other reference point with a tape measure, and then transferring the measurement and outline of the hole to be cut to the backerboard. An improvised outline is typically sketched on the surface of the backerboard with a pencil, followed by removal of the section of the backerboard to be cut out by a saw or drill. This traditional method has several disadvantages. First, it is susceptible to measurement errors, and if the wrong reference point is used, or the dimensions are incorrectly transferred, then the holes or notches to be cut on the backerboard will be incorrectly located. In this case, additional measurements are taken and transferred, usually resulting in another set of holes or notches in the backerboard, Second, the hole or notch for the protrusion is typically enlarged by the backerboard installer to allow for measurement inaccuracies. In either case, the results are enlarged or mislocated holes or notches which degrade the integrity of the backerboard, which may allow moisture to penetrate into the wall cavity or subfloor; reduction in the tile bonding surface, making for a weaker bonding of tile to the affected portions of the backerboard; and additional time and labor expense. It would be desirable to provide a composite board for use as a tile backerboard with at least one outer planar surface that is smooth and soft enough to allow a tile backerboard installer to locate the backerboard on the wall or floor where the backerboard is to be installed, and simply press the backerboard against the wall or floor protrusions to emboss the features of the protrusions on the smooth surface of the backerboard, to allow the installer to then remove the exact portion required by a saw, drill or utility knife, for example.

One conventional cementitious board structure provides reinforcement extending in the plane of the board as well as transverse to the plane of the board, with a spatial fabric extending throughout substantially the whole of the reinforced structure in three dimensions for improved strength of the cement structures. Another conventional cementitious board provides outer reinforcement layers having a three-dimensional web of non-woven fibers extending in the plane of the board as well as transverse to the plane of the board to provide a rigidified panel. Such rigid cementitious boards have exterior surfaces that do not permit embossing of features on the surface of the cementitious board.

Accordingly, there is a long-standing need to provide a backerboard that is lightweight, rigid, economical and easy to install with common fasteners, and that provides reinforcement substantially in the plane of the composite board, while presenting a surface texture that is soft enough to allow embossing of features on the surface of the composite board. The present invention satisfies these and other needs.

### SUMMARY OF THE INVENTION

The present invention provides a composite board suitable for use as a tile backerboard. The composite board generally includes a middle planar polystyrene layer or core, and first and second outer reinforced cement portions on the planar sides of the polystyrene layer. As a tile backerboard the composite construction provides a backerboard that is lightweight, rigid, economical and easy to install. Problems of enlarged or mislocated holes or notches in installation of the composite board as a tile backerboard are eliminated by use of the composite board of the invention as a tile backerboard, having an outer planar surface that is smooth and soft enough to permit embossing of features of wall or floor protrusions on the surface of the backerboard to accurately mark holes to be cut in the backerboard.

In one implementation, the composite board is formed as a three-part composite board for use as a tile backerboard. For clarity purposes the composite board may be referred to as including top and bottom outer reinforcement portions, and a center core portion. In practice, the top and bottom reinforcement portions may be interchanged. In one aspect, a planar center portion or core portion is formed from polystyrene, such as expanded polystyrene, for example, which is relatively inexpensive, and which may be fused to be waterproof. The polystyrene layer may be cut from a molded expanded polystyrene billet, or may be individually molded.

In another aspect, one or both of the top and bottom portions may be formed as outer reinforcement portions from a combination of a relatively inexpensive mat incorporating non-woven or woven fiberglass fibers, which may have an alkali resistant coating, such as an acrylic coating, for example, and a non-shrinking cement compound. In this configuration the non-shrinking cement compound may be saturated into the mat fabric. When combined with the cement compound the mat becomes relatively rigid in the plane of the composite board, providing a smooth soft surface largely unreinforced in a direction transverse to the plane of the board, simplifying the layout for the holes for plumbing fixtures in walls by allowing the embossing of features thereon, and permitting the composite board to be easily conformed to a flat mounting surface on which the composite board may be mounted. The top and bottom reinforcement portions may be bonded to the center portion with the non-shrinking cement compound. In an alternate aspect, one of the top and bottom reinforcement portions may be formed from a combination of a mesh fabric such as a woven polypropylene fabric, and a non-shrinking cement compound.

In practice the composite board is lightweight, rigid, economical and easy to install because of its unique composite construction. The low weight is partly due to the board's expanded polystyrene layer while the rigidity is provided by the reinforced cement layers joined to the polystyrene layer. The composite board is also economical because of the low cost expanded polystyrene center section. The composite board is also easily sized because only one of the top and bottom reinforcement portions must be scored to break the board, and may be easily attached to a supportable wall with conventional fasteners.

Other features and advantages of the invention will become apparent from the following detailed description, taken in conjunction with the drawings, which illustrate, by way of example, the features of the invention.

### BRIEF DESCRIPTION OF THE DRAWINGS

FIG. 1 is a perspective exploded view of a first embodiment of a composite board according to the invention.

FIG. 2 is a sectional view of the composite board of FIG. 1.

FIG. 3 is a plan view of the mesh portion of the composite board of FIG. 1.

FIG. 4 is a plan view of the mat portion of the composite board FIG. 1.

FIG. 5 is a perspective view of the composite board FIG. 1 fastened to a wooden substrate.

FIG. 6 is a cross-sectional view taken along lines 6-6 of FIG. 5.

FIGS. 7A and 7B are elevational diagrammatic views of a board manufacturing apparatus according to the invention, FIG. 7B differing somewhat in scale from FIG. 7A for clarity.

FIG. 8 is a perspective exploded view of a second embodiment of a composite board according to the present invention.

FIG. 9 is a sectional view of the composite board of FIG. 8.

FIG. 10 is a plan view of the mat portion of the composite board FIG. 8.

FIG. 11 is a perspective view of the composite board FIG. 8 fastened to a wooden substrate.

FIG. 12 is a cross-sectional view taken along lines 12-12 of FIG. 11.

FIG. 13 is a plan view of the mat portion of the composite board FIG. 8, showing the feature of a protruding pipe fixture embossed as a circular depression thereon.

### DETAILED DESCRIPTION OF THE PREFERRED EMBODIMENTS

The present invention is directed to a composite board that is lightweight, rigid, economical and easy to install. In the following embodiments, the board is configured to be used as a tile backerboard.

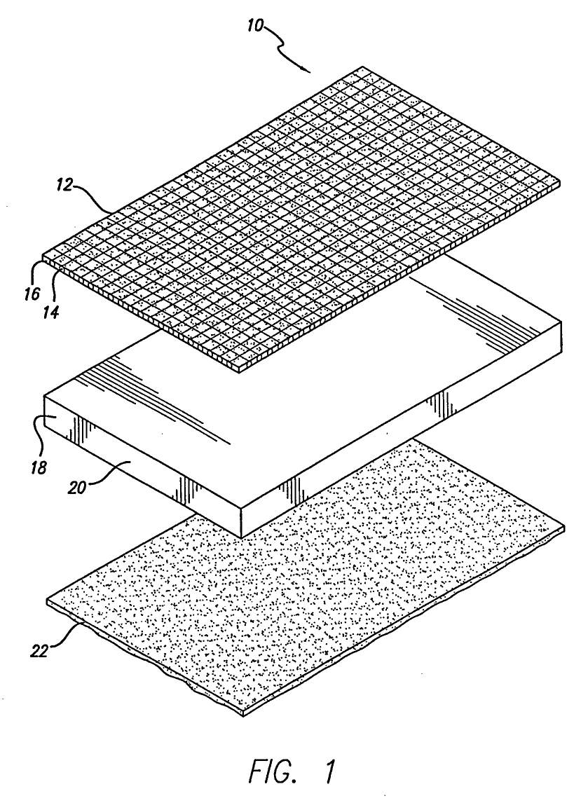

An exploded view of a first embodiment of a composite tile backerboard 10 is shown in FIG. 1 incorporating essentially three portions. As shown, a first outer or top portion 12 includes a combination of a woven mesh fabric 14 and a cement compound 16 to form a mesh fabric layer, a planar center portion or core 18 includes an expanded polystyrene 20 to form a polystyrene layer and a second outer or bottom portion 22 includes a combination of a mat fabric 24 and a cement compound 16 to form a mat layer (shown in FIG. 4). For clarity purposes, the composite board is referred to as including top, bottom and center portions while in practice the top and bottom portions may be interchanged.

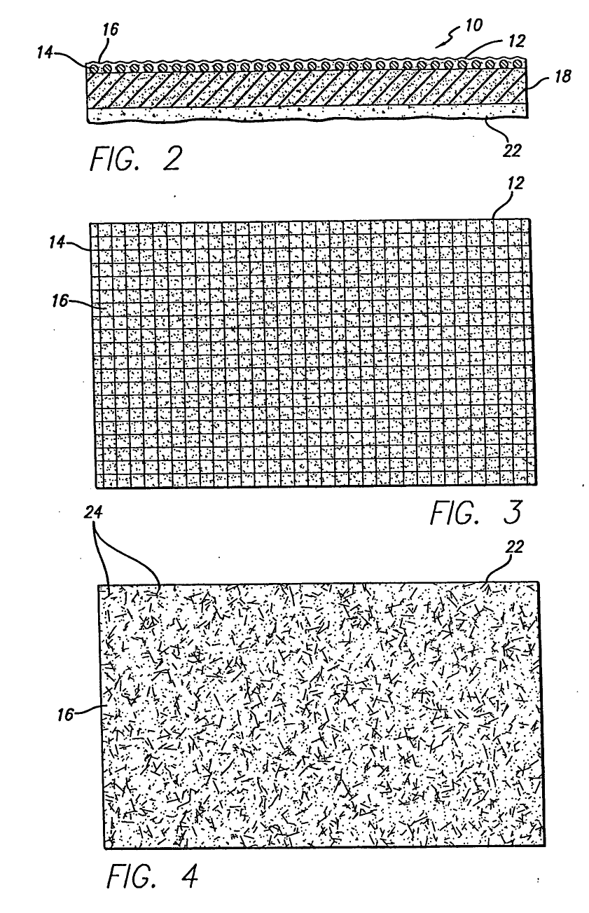

The three layers of the composite board 10 including the mesh layer 12, polystyrene layer 18 and mat layer 22 are shown in FIG. 2. The mesh layer is approximately 1 mm thick, the polystyrene layer is approximately 9 mm thick and the mat layer is approximately 1 mm thick. The thicknesses of each layer can vary to give the board a total width of approximately 6 to 14 mm. The board is also usually configured with a width of approximately 3 to 4 feet and a length of approximately 4 to 12 feet. In its complete form, the board weighs approximately 0.5 to 1.0 pounds per square foot.

The mesh layer 12 as shown in FIG. 3 includes a combination of a woven mesh fabric 14, such as a woven mesh fabric of polypropylene, for example, and a non-shrinking cement compound 16. The mesh fabric has a grid-like pattern with square openings 28 of about 0.25 inch by 0.25 inch of which the sizes can be reduced to 0.0625 inch by 0.0625 inch depending on design requirements. The relatively small 0.25 inch openings in this preferred embodiment are well suited to standard housing fasteners such as nails or screws and do not necessitate the use of washers because at least three strands of mesh are likely to be captured by a common fastener. The grid-like pattern also helps retain mortar which may be applied to affix tiles in a vertical fashion to the board with a strong mechanical bond. The non-shrinking cement compound is saturated into the mesh fabric, providing rigidity, a solid surface to adhere mortar to and a non-shrinking property to the mesh layer. The mesh fabric is coated with enough cement compound slurry to adhere it to the polystyrene layer 18 and yet still leave a textured surface. This texturing has more surface area than a smooth surface, or one with wider mesh spacing. With greater surface area to bond to, there is greater bond strength between the tile and the backerboard 10. In addition, the rough surface creates a mechanical bond between the adhesive and the board. The combination of the mesh fabric and the cement compound that make up the mesh layer is approximately 1 mm thick.

The polypropylene mesh 14 also has many inherent features such as elasticity, resistance to cement alkalinity, low cost and large diameter strands which make a desirable texture. The elasticity of the mesh is such that the strands will elongate when under the forces of a fastener or impact of a hammer. This allows the mesh to stretch as the fastener is driven into the panel and not break. In another form, the mesh may be non-alkali resistant and thereafter coated with an alkali resistant coating to be compatible with the cement compound.

The non-woven mat layer 22 shown in FIG. 4 includes a combination of a non-woven mat fabric 24 such as fiberglass, for example, with an alkali resistant coating, such as an acrylic coating, for example, and a non-shrinking cement compound 16. In an alternate aspect, the fiberglass mat fabric may be woven. The mat fabric typically incorporates fiberglass fibers, while the acrylic coating prevents the mat from being detrimentally affected by the alkalinity of the non-shrinking cement compound. With its relatively smooth surface, the mat portion is well suited to be fitted up against a flat surface such as a stud. The mat is also economical, being less expensive than a similarly sized mesh fabric. In addition, the fibers tend to stretch less than mesh weaves. This provides the board with a strong resistance to bending when the mat side is abutted to a series of studs where the most common force on a wall is a pressing between the studs. The mat layer has the greatest accumulation of tensile stresses as the tile wall is leaned against or pressed, therefore the reinforcement requirements on this surface are different than those on the tile surface. The random nature of the fiber distribution in the mat fabric, along with the low elasticity of fiberglass provides tensile strength reinforcement within the X-Y plane of the mat layer, but substantially no reinforcement in a direction transverse to the plane of the composite board, making the outer surface of the mat layer relatively soft to allow embossing of features, such as of pipes or other plumbing fixtures, for example, on the surface of the mat layer. In this manner, a tile backerboard installer can place the backerboard against the wall or floor where the backerboard is to be installed, and simply press the backerboard against a wall or floor with one or more protrusions to emboss the features of the protrusions on the smooth surface of the backerboard, allowing the installer to then make a hole or notch matching the outline of the features of the protrusions, as will be further explained below. The combination of the mat fabric and the cement compound that make up the mat layer is approximately 1 mm thick.

The cement compound slurry 16 adheres the fabric to the expanded polystyrene core 18, provides a cementitious surface for tile bonding mortars to adhere to, and provides compressive strength which helps to stiffen the board 10. Non-shrink additives may be added to the cement compound slurry to minimize the shrinking of the slurry on the board as it is cured. Shrinkage of the slurry during the curing process may cause the panels to warp and become non-flat. Polymers may also be added to the cement compound slurry to increase the adhesion between the slurry and the mesh and mat fabrics.

In a presently preferred aspect, the non-shrinking cement compound includes approximately 20-35% by weight Portland cement, approximately 20-35% by weight calcium aluminate cement, approximately 10-40% by weight silica sand, approximately 2-6% by weight vinyl acetate-ethylene (VAE) copolymer, approximately 0-0.25% cellulose ether, approximately 0.5 to 1% by weight of a surfactant, and approximately 10-20% gypsum. Other commercially available types of non-shrinking cement may also be suitable.

In general, the expanded polystyrene 20 of the polystyrene layer 18 has a lower modulus of elasticity than extruded polystyrene. Using the mesh/mat combination as a reinforcement helps to stiffen the polystyrene layer. The polystyrene layer is commonly available in block molded, expanded polystyrene where large blocks of expanded polystyrene are formed and then sliced into thin cores. The density of the polystyrene is approximately 1.0 to 4.0 lb/ft3 with the layer being approximately 9 mm thick. In conjunction with the mat layer 22, the polystyrene layer enables a builder to easily score the composite to size, needing only to score the mat side of the board. In addition to providing structural support for the composite board and to providing matting surfaces on both sides of the board, the non-shrinking cement compound 16 adheres the mesh layer 12 and the mat layer to the polystyrene layer. The non-shrinking properties of the cement compound enable the composite board to remain flat after the mesh layer and mat layer have adhered to the polystyrene layer and after drying. At the present time, this is one of the most economical ways to produce expanded polystyrene cores. The invention can also incorporate other forms of expanded polystyrene such as individually molded planks if economies of scale warrant the use of this technology.

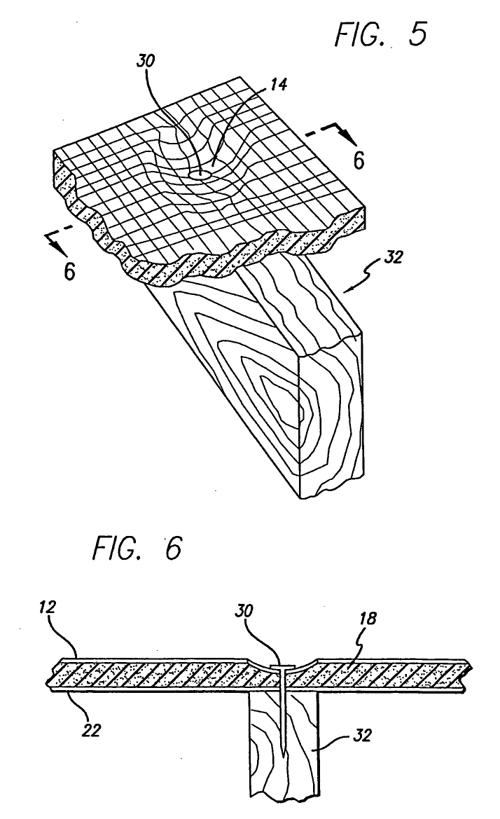

The composite board 10 is shown fastened to a wooden substrate 32 in FIG. 5. A fastener 30 in the form of a roofing nail secures the composite board to a wooden substrate. The mesh fabric 14 is elongated due to the force of a hammer impacting the fastener. As shown in FIG. 6, the fastener compresses the polystyrene layer 18 along with elongating the mesh fabric. The respective compression and elongation helps to retain the fastener. Neither the polystyrene nor the mesh is detrimentally affected by the distortion, rather both are suitably flexible for the respective compression and elongation. The mat layer 22 remains substantially flat in abutting the wooden substrate.

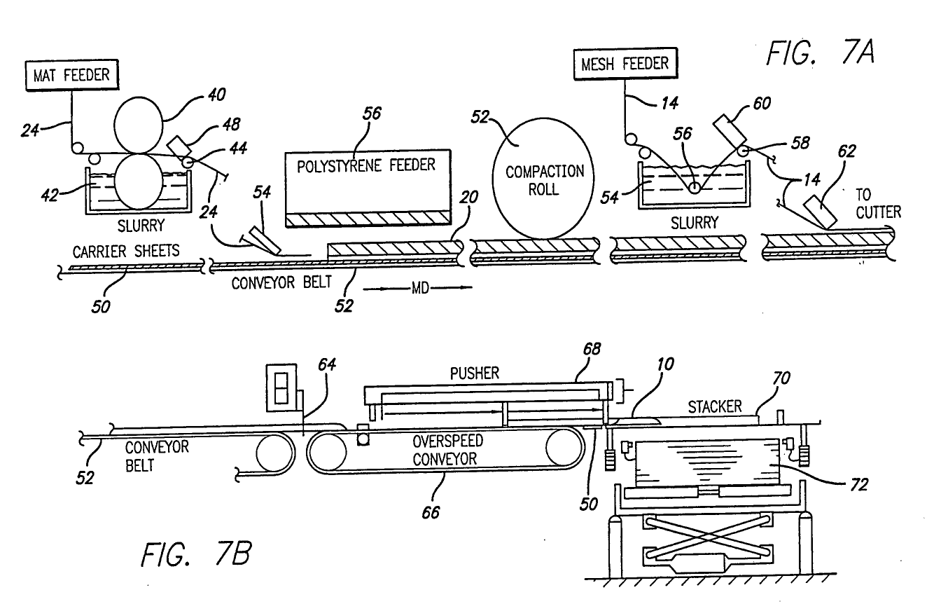

FIGS. 7A and 7B diagrammatically illustrate the features of a composite board manufacturing process. Considering FIGS. 7A and 7B, it will be seen that a continuous web of approximately three feet wide continuous length mat fabric 24 is fed through a roll coater 40 wherein the slurry material 42 therein constitutes a hydraulic cement mixture. As shown in FIG. 7A, the mat fabric is drawn through the roll coater by virtue of a roller 44 such that the hydraulic cement is applied to both sides of the mat fabric. Thereafter, the mat fabric is pulled from the roll coater and an adjustable doctoring blade or metering apparatus 48 can be adjusted to control the amount of slurry actually applied to the mat.

From the metering apparatus 48, the mat fabric then travels downwardly to a point where it is laid onto a plurality of oiled carrier sheets 50. Each of the carrier sheets is supported and conveyed by a conveyor belt 52 with the sheets in abutting relationship so that a forward end of each carrier sheet preferably contacts the trailing end of a preceding carrier sheet. While it may be possible to lay the slurried mat fabric onto carrier sheets which are spaced apart, it is preferable to lay the carrier sheets end to end in abutting relationship as described in order to maintain uniformity of the board face. The carrier sheets can be placed on the conveyor belt upstream of the slurry bath by any appropriate means, which do not constitute part of this invention.

Continuing now with the description of the method by which the board 10 is formed, the slurried mat fabric is laid down on the carrier sheets by virtue of a drag bar 54, which is positioned above the mat fabric and which drags against its upper surface, thereby serving to urge hydraulic cement on the upper surface of the mat fabric into the interstices of the mat fabric and through the mat fabric. It should be appreciated, however, that the drag bar does not remove or scrape from the mesh all of the hydraulic cement, but rather leaves a quantity of cement compound on the upper surface of the mat fabric.

Proceeding from the drag bar 54, the conveyed carrier sheets and mat fabric move beneath the polystyrene feeder 56. The polystyrene feeder transfers the polystyrene cores 20 which are approximately three feet wide onto the slurried mat fabric.

Thereafter, the conveyor belt moves the abutting carrier sheets 50, the mat layer 22 and the polystyrene core into a compaction station formed by compaction roll 52, which serves to compact the polystyrene core against the mat layer. This enhances the bond of the slurried mesh to the core.

Thereafter, an approximately three foot wide continuous length mesh fabric 14 is fed through a slurry bath or trough 54 containing a slurry, also of the hydraulic cement-mixture previously described. The mesh fabric is drawn through the bath 54 by virtue of the roller 56, and thereafter past roller 58 and a second adjustable doctor blade or metering apparatus 60 for controlling the amount of slurry applied to the mesh fabric. Both metering apparatus 48 and 60, and the roll coater and slurry bath can be of any suitable form. The slurry metering can be accomplished in any suitable fashion.

From the metering apparatus 60, the mesh fabric 14 is conveyed onto the upper surface of the compacted polystyrene core 20 by virtue of a second drag bar 62 at which point the mesh is laid down on top of the polystyrene core. The drag bar is operable to urge the hydraulic cement on the mesh fabric into the interstices thereof and through the mesh, so that a sufficient amount of hydraulic cement resides on lower surface of the mesh fabric and thereby contacts the surface of the polystyrene core for bonding thereto. Subsequent stacking for curing serves to enhance the bond.

From the drag bar 62, the composite board 10, including a slurried lower mat layer 22, a polystyrene layer 18 and a slurried upper mesh layer 12, is conveyed into a cutter station as depicted in FIG. 7B. This illustration, for clarity, shows the formed panel web in lesser detail than in FIG. 7A.

The cutter station includes a cutter 64 for moving transversely across the formed composite board and cutting the board between adjacent and abutting carrier sheets to approximately three feet in length. The details of the cutter will be hereinafter described.

From the cutter 64, the now individual composite board 10, and its respective carrier sheet 50, is conveyed onto an overspeed conveyor 66 operating at a speed in excess of that of conveyor 52, to separate a cut board and carrier sheet from the integral semi-continuous formed board upstream of the cutter. Once the now cut board and associated carrier sheet is moved onto the overspeed conveyor, it is sensed, as will be described, and is pushed from the overspeed conveyor, via pusher 68, onto the stacking apparatus 70. Stacker serves to form a stack 72 of assemblies, each of which comprise a carrier sheet with a composite board 10 thereon. When a full stack is formed, the stack is conveyed away from the stacking apparatus for further curing and storing. Once cured, the boards are ready for use in many construction and remodeling applications. As will be appreciated, various panel face texturizing means could be provided to texturize the hydraulic cement on the panel face to any desired design. In addition, the edges of the composite boards are preferably painted with the slurry cement to provide the finished panel with the appearance of having a cementitious core like traditional cementitious backerboards, and to help to seal the edges of the finished panels from moisture.

The embossing of features has been found to be resisted in a direction transverse to the plane of the composite board by the mesh of a mesh layer described above, resulting in partial or shallow embossing of features which can then be difficult to discern. However, the reinforcement portion formed by the mat fabric layer provides primarily a planar reinforcement in the plane of the mat fabric layer, with substantially no reinforcement provided in a direction transverse to the plane of the composite board, providing little resistance to embossing the composite board surface, and allowing deep clear embossment into the soft polystyrene core, as will be further explained below.

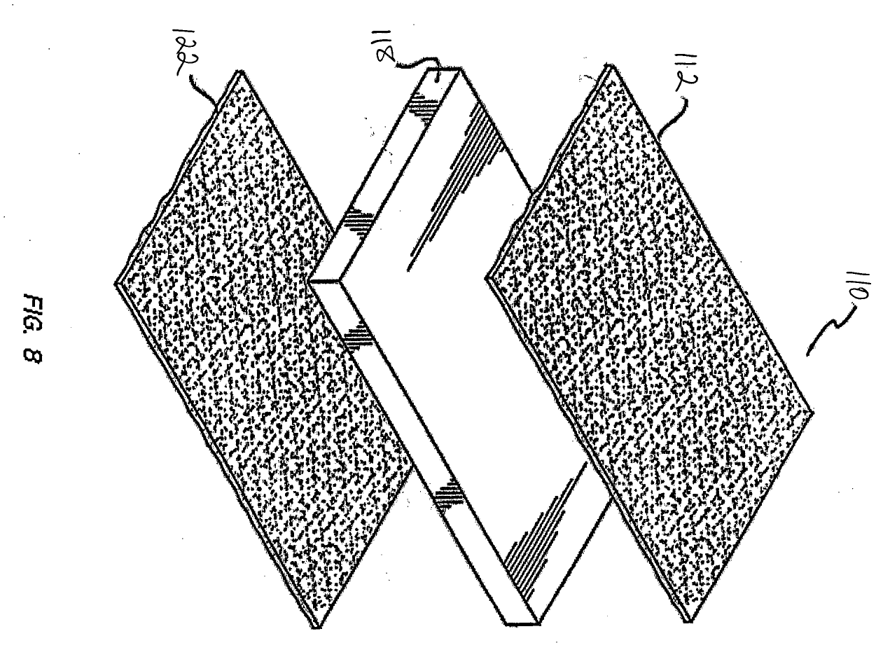

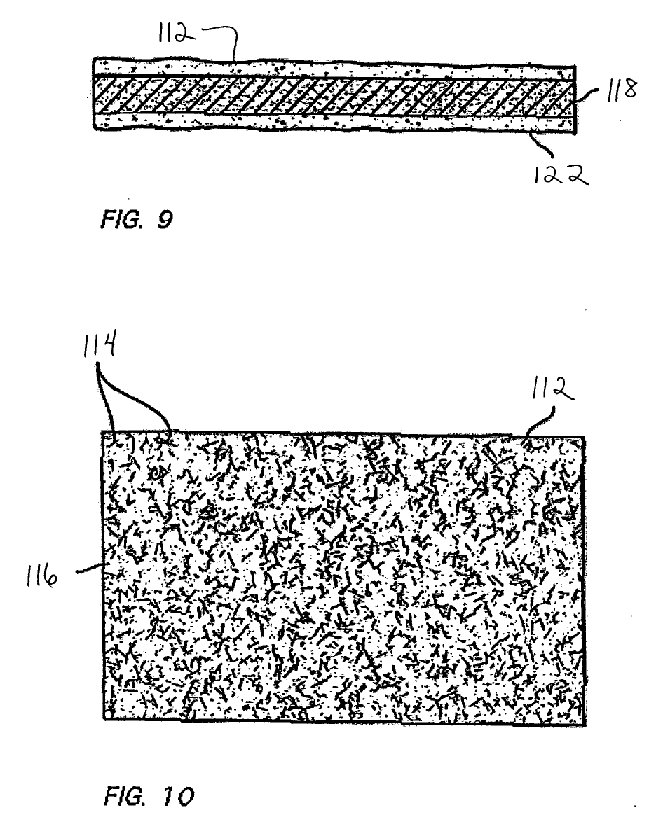

Accordingly, in a second presently preferred embodiment of the invention illustrated in FIGS. 8-13, the composite tile backerboard 110 includes a first outer or top reinforcement portion 112, or first mat fabric reinforcement layer, formed of a combination of a non-woven mat fabric 114 and a cement compound 116, such as a non-shrinking cement compound. The composite tile backerboard also includes a planar center portion or core 118, or polystyrene layer, formed of expanded polystyrene. In general, the expanded polystyrene of the polystyrene layer has a lower modulus of elasticity than extruded polystyrene. Using the mat fabric reinforcement layer as a reinforcement helps to stiffen the polystyrene layer. The polystyrene layer is commonly available in block molded, expanded polystyrene where large blocks of expanded polystyrene are formed and then sliced into thin cores. The density of the polystyrene is approximately 1.0 to 4.0 lb/ft3 with the layer being approximately 9 mm thick. The polystyrene layer enables a builder to easily score the composite to size, needing only to score one mat side of the board.

In a presently preferred aspect, the composite tile backerboard also includes a second outer or bottom portion 122, or second mat fabric reinforcement layer, formed of a combination of a mat fabric and a cement compound, such as a non-shrinking cement compound, identical to the first mat fabric reinforcement layer. The first and second mat fabric reinforcement layers each typically include a combination of a non-woven mat fabric such as fiberglass, with an alkali resistant coating, such as an acrylic coating, for example. The acrylic coating prevents the mat from being detrimentally affected by the alkalinity of the non-shrinking cement compound.

The fiber distribution in the mat fabric, along with the low elasticity of fiberglass provides tensile strength reinforcement within the X-Y plane of the mat layer, but substantially no reinforcement in a direction transverse to the plane of the composite board, making the outer surface of the mat layer relatively soft to allow embossing of features, such as of pipes or other plumbing fixtures, for example, on the surface of the mat layer, as explained further below.

The first and second mat fabric reinforcement layers are each approximately 1 mm thick, and the polystyrene layer is approximately 9 mm thick. The thicknesses of each layer can vary to give the board a total width of approximately 6 to 14 mm. The board is also usually configured with a width of approximately 3 to 4 feet and a length of approximately 4 to 12 feet. In its complete form, the board weighs approximately 0.5 to 1.0 pounds per square foot.

The cement compound slurry adheres the fabric to the expanded polystyrene core, provides a cementitious surface for tile bonding mortars to adhere to, and provides compressive strength which helps to stiffen the board. Non-shrink additives may be added to the cement compound slurry to minimize the shrinking of the slurry on the board as it is cured. Shrinkage of the slurry during the curing process may cause the panels to warp and become non-flat. Polymers may also be added to the cement compound slurry to increase the adhesion between the slurry and the mesh and mat fabrics.

In a presently preferred aspect, the non-shrinking cement compound includes approximately 20-35% by weight Portland cement, approximately 20-35% by weight calcium aluminate cement, approximately 10-40% by weight silica sand, approximately 2-6% by weight vinyl acetate-ethylene (VAE) copolymer, approximately 0-0.25% cellulose ether, approximately 0.5 to 1% by weight of a surfactant, and approximately 10-20% gypsum. Other commercially available types of non-shrinking cement may also be suitable.

In addition to providing structural support for the composite board and to providing matting surfaces on both sides of the board, the non-shrinking cement compound adheres the first and second mat reinforcement layers to the polystyrene layer. The non-shrinking properties of the cement compound enable the composite board to remain flat after the first and second mat reinforcement layers have adhered to the polystyrene layer and after drying. At the present time, this is one of the most economical ways to produce expanded polystyrene cores. The invention can also incorporate other forms of expanded polystyrene such as individually molded planks if economies of scale warrant the use of this technology.

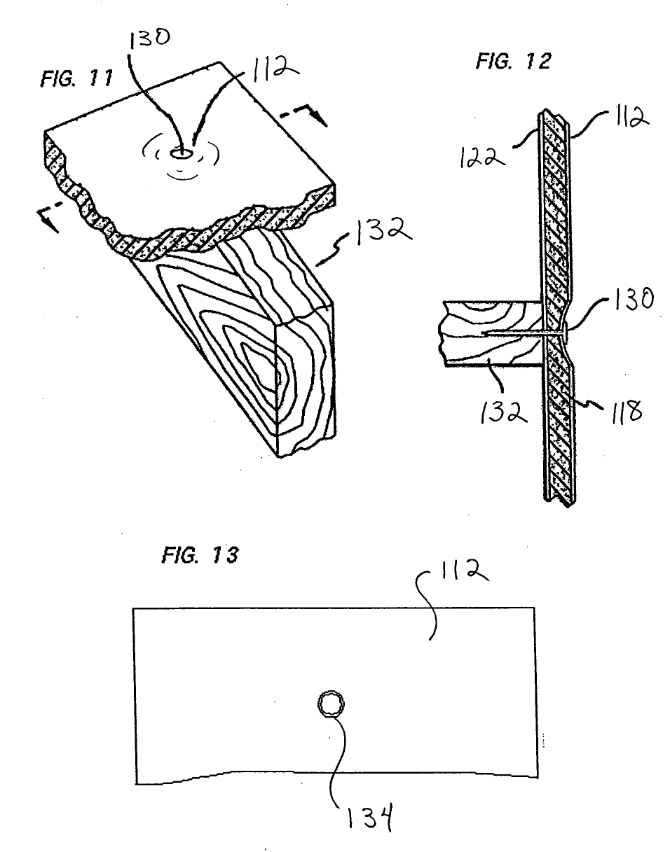

The composite board is shown fastened to a wooden substrate 132 in FIG. 11. A fastener 130 in the form of a roofing nail secures the composite board to a wooden substrate. As shown in FIG. 12, the fastener compresses the polystyrene layer and the mat fabric reinforcement layer. The second mat reinforcement layer 122 remains substantially flat in abutting the wooden substrate.

As is illustrated in FIG. 13, in the method of embossing features of protrusions on the composite board used as a tile backerboard, an installer can place the backerboard against the wall or floor where the backerboard is to be installed, and simply press the backerboard against a wall or floor with one or more fixtures protruding from the wall or floor to emboss features of the protrusions on the smooth, impressionable surface of the backerboard, making a deep clear embossment of the features of the protrusions into the soft polystyrene core, such as the circular depression 134 of a protruding pipe fixture (not shown). Thereafter, the installer can cut a hole or notch in the composite board matching the outline of the features of the protrusions, such as with a saw, drill or utility knife, or using any other similar suitable cutting tool or process for example.

It will be apparent from the foregoing that, while particular forms of the invention have been illustrated and described, various modifications can be made without departing from the spirit and scope of the invention. Accordingly, it is not intended that the invention be limited, except as by the appended claims.

We claim:

1. A composite tile backerboard for application to a flat surface, comprising:
an expanded polystyrene planar core having top and bottom planar sides, the expanded polystyrene planar core extending in a plane of the composite tile backerboard; and
first and second outer reinforcement portions bonded to said top and bottom planar sides of said expanded polystyrene planar core, at least one of said first and second outer reinforcement portions comprising a mat fabric reinforcement portion including a planar reinforcement mat fabric and a cement compound, the mat fabric having fibers extending in the plane of the mat fabric reinforcement portion, substantially providing reinforcement of said expanded polystyrene planar core in the plane of the composite tile backerboard, and substantially not providing reinforcement of said expanded polystyrene planar core in a direction transverse to the plane of the composite tile backerboard.

2. The composite tile backerboard of claim 1, wherein said planar reinforcement mat fabric comprises a non-woven fiberglass mat fabric with an alkali coating, the fiberglass mat fabric having the smooth surface that is conformable to the flat surface and to said protruding fixtures.

3. The composite tile backerboard of claim 1, wherein one of said first and second reinforcement portions comprises a woven mesh fabric.

4. The composite tile backerboard of claim 3, wherein the cement compound is non-shrinking.

5. The composite tile backerboard of claim 3, wherein the woven mesh fabric is saturated with the cement compound.

6. The composite tile backerboard of claim 3, wherein the woven mesh fabric is formed in a grid-like pattern.

7. The composite tile backerboard of claim 1, wherein the cement compound comprises:
approximately 20-35% by weight Portland cement;
approximately 20-35% by weight calcium aluminate cement;
approximately 10-40% by weight silica sand;
approximately 2-6% by weight vinyl acetate-ethylene copolymer;
approximately 0-0.25% cellulose ether;
approximately 0.5 to 1% by weight of a surfactant; and
approximately 10-20% gypsum.

8. A composite tile backerboard for application to a flat surface, comprising:
an expanded polystyrene planar core having top and bottom planar sides, the expanded polystyrene planar core extending in a plane of the composite tile backerboard; and
first and second outer mat fabric reinforcement portions bonded to said top and bottom planar sides of said expanded polystyrene planar core, each of said first and second outer mat fabric reinforcement portions extending in a plane parallel to the plane of the composite tile backerboard, at least one of said first and second outer mat fabric reinforcement portions including a non-woven mat fabric having fibers extending in the planes of the mat fabric reinforcement portions, respectively, and a cement compound, so as to substantially provide reinforcement in said planes of the mat fabric reinforcement portions, respectively, and to substantially not provide reinforcement in a direction transverse to the plane of the composite tile backerboard, to thereby permit embossing of plumbing layout marks on said outer reinforcement portion including said non-woven mat fabric by pressing the surface of said outer mat fabric reinforcement portions against fixtures protruding from the flat surface.

9. The composite tile backerboard of claim 8, wherein the non-woven mat fabric is comprised of a fiberglass mat fabric with an alkali coating.

10. The composite tile backerboard of claim 9, wherein the cement compound is non-shrinking.

11. The composite tile backerboard of claim 8, wherein the non-woven mat fabric is saturated with the cement compound.

12. The composite tile backerboard of claim 8, wherein the cement compound comprises:
approximately 20-35% by weight Portland cement;
approximately 20-35% by weight calcium aluminate cement;
approximately 10-40% by weight silica sand;
approximately 2-6% by weight vinyl acetate-ethylene copolymer;
approximately 0-0.25% cellulose ether;
approximately 0.5 to 1% by weight of a surfactant; and
approximately 10-20% gypsum.

13. A method of installing a composite tile backerboard to a flat surface having a fixture protruding from the flat surface, comprising:
providing a composite tile backerboard including an expanded polystyrene planar core having top and bottom planar sides, the expanded polystyrene planar core extending in a plane of the composite tile backerboard, and first and second outer reinforcement portions bonded to said top and bottom planar sides of said expanded polystyrene planar core, at least one of said first and second outer reinforcement portions comprising a mat fabric reinforcement portion including a planar reinforcement mat fabric and a cement compound, the mat fabric having fibers extending in the plane of the mat fabric reinforcement portion, substantially providing reinforcement of said expanded polystyrene planar core in the plane of the composite tile backerboard, and substantially not providing reinforcement of said expanded polystyrene planar core in a direction transverse to the plane of the composite tile backerboard;
placing the mat fabric reinforcement portion of the composite tile backerboard against the flat surface and the fixture protruding from the flat surface;
pressing the mat fabric reinforcement portion of the composite tile backerboard against the fixture protruding from the flat surface to emboss features of the fixture protruding from the flat surface on the surface of the mat fabric reinforcement portion of the composite tile backerboard; and
cutting a hole in the composite tile backerboard based upon the features of the fixture embossed on the surface of the mat fabric reinforcement portion of the composite tile backerboard.

14. A method of installing a composite tile backerboard to a flat surface having a fixture protruding from the flat surface, comprising:
providing a composite tile backerboard including an expanded polystyrene planar core having top and bottom planar sides, the expanded polystyrene planar core extending in a plane of the composite tile backerboard, and first and second outer mat fabric reinforcement portions bonded to said top and bottom planar sides of said expanded polystyrene planar core, each of said first and second outer mat fabric reinforcement portions extending in a plane parallel to the plane of the composite tile backerboard, at least one of said first and second outer mat fabric reinforcement portions including a non-woven mat fabric having fibers extending in the planes of the mat fabric reinforcement portions, respectively, and a cement compound, so as to substantially provide reinforcement in said planes of the mat fabric reinforcement portions, respectively, and to substantially not provide reinforcement in a direction transverse to the plane of the composite tile backerboard;
placing a selected one of said mat fabric reinforcement portions of the composite tile backerboard against the flat surface and the fixture protruding from the flat surface;
pressing said selected one of said mat fabric reinforcement portions of the composite tile backerboard against the fixture protruding from the flat surface to emboss features of the fixture protruding from the flat surface on the surface of said selected one of said mat fabric reinforcement portions of the composite tile backerboard; and
cutting a hole in the composite tile backerboard based upon the features of the fixture embossed on the surface of said selected one of said mat fabric reinforcement portions of the composite tile backerboard.
